(19) United States
(12) Patent Application Publication
(10) Pub. No.: US 2004/0186724 A1
(43) Pub. Date: Sep. 23, 2004

(54) Hands-free speaker verification system relying on efficient management of accuracy risk and user convenience

(76) Inventor: Philippe Morin, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/392,156

(22) Filed: Mar. 19, 2003

(51) Int. Cl. G10L 21/00

(52) U.S. Cl. 704/273

(57) ABSTRACT

A speaker verification system for use with a security system includes a data store containing a speaker voiceprint model developed from speaker utterances of a pass phrase. It also includes an audio input receptive of an audio input stream. It further includes a verification module adapted to match a sub-model portion of the voiceprint model to a sub-stream portion of the input stream and issue a speaker verification. The system strikes a balance between accuracy risk and user convenience by using continuous speech recognition, a lengthy pass phrase, and matching relative to duration of the spotted sub-portion, and relative to an amount of additional training to which the corresponding states of the model have been submitted. Thus, the system can achieve accurate speaker verifications, while speakers may enroll with reduced repetitions, use the system hands-free, and experience reduced requirements for speaking most or all of the pass phrase over time.

### FIELD OF THE INVENTION

The present invention generally relates to speaker verification systems utilizing password-based voiceprint models, and particularly relates to speaker verification systems and methods verifying speakers by matching sub-model portions of voiceprint models to sub-stream portions of an audio input stream.

### BACKGROUND OF THE INVENTION

Biometric user authentication by voice, also known as speaker verification, has application wherever an identity of a person needs to be verified. Example areas of application for speaker verification systems and methods include door access systems, personal computer login, and cellular phone voice lock. Unfortunately, today's speaker verification systems focus primarily on security, and possess many features that inconvenience a user.

The inconvenient operational features possessed by today's speaker verification systems are numerous and varied. For example, many speaker verification systems tend to burden users with a push-to-talk button and/or a menu/voice-prompted dialogue scenario. The burden placed on the user is further amplified when the initial verification turn fails due to stationary or non-stationary noise events present in the the operational environment. Sample non-stationary noise events include doors closing, birds chirping, cellular phones ringing and people talking at a distance. When the identity of the speaker cannot be verified during the initial verification turn, sub-sequent turns are typically requested from the user. This request can be achieved by asking the user to repeat the password or to say a secondary password. As a result, the time required to complete an entire verification process can be excessively long.

There remains a need for a speaker verification system and method that efficiently reduces the operational burden on the user while maintaining a sufficiently high level of security. Such a system and method should reduce the requirement to perform repetitions in most cases to a minimum. The present invention fulfills the aforementioned need while effectively eliminating the requirement for subsequent dialogue turns.

### SUMMARY OF THE INVENTION

A speaker verification system for use with a security system includes a data store containing a speaker voiceprint model developed from speaker utterances of a pass phrase. The system includes an audio input device receptive of an audio input stream. In another aspect, it has a verification module adapted to find a match between a sub-model portion of the voiceprint model and a sub-stream portion of the input stream based on similarity between the sub-model portion and the sub-stream portion, and adapted to issue a speaker verification based on the match.

The speaker verification system according to the present invention is advantageous over previous speaker verification systems because it efficiently strikes a balance between accuracy risk and user convenience. Accordingly, the preferred embodiment uses continuous speech recognition to find via spotting an admissible alignment between a sub-model portion of a lengthy voiceprint model and a sub-stream portion of the input stream that yields an acceptable degree of similarity between the sub-model portion and the sub-stream portion. In yet another aspect, the preferred embodiment decides upon the admissibility of an alignment by checking whether or not that alignment can satisfy a set of constraints relative to the duration of the aligned portion and relative to the amount of additional training to which the corresponding states of the model have been submitted. Thus, the preferred embodiment issues a decision of acceptance or a decision of rejection based on the quality of the match for each alignment that is hypothesized, and continuously develops the voiceprint model over time to improve both verification accuracy and user convenience. As a result, the system can achieve accurate speaker verification results under adverse conditions, while a speaker may enroll with reduced repetitions, use the system hands-free, and experience reduced requirements for speaking most or all of the pass phrase over time.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a block diagram depicting a speaker verification system according to the present invention;

FIG. 2 illustrates a flow diagram depicting a speaker enrollment method according to the present invention;

FIG. 3 illustrates a flow diagram depicting a speaker verification method according to the present invention;

FIG. 4 illustrates a graph depicting a two-dimensional local distance array demonstrating local distance recordation accomplished via a similarity scoring technique according to the present invention;

FIG. 5 illustrates a graph depicting a two-dimensional accumulation score array demonstrating accumulation score recordation accomplished via a similarity scoring technique according to the present invention;

FIG. 6 illustrates a graph depicting a two-dimensional multiple path array demonstrating multiple path recordation accomplished via a similarity scoring technique according to the present invention; and

FIG. 7 illustrates a graph depicting a two-dimensional sub-model spotting array demonstrating sub-model spotting recordation accomplished via a similarity scoring technique according to the present invention.

### DETAILED DESCRIPTION OF THE PREFERRED EMBODIMENT

The following description of the preferred embodiments is merely exemplary in nature and is in no way intended to limit the invention, its application, or uses.

The present invention is a speaker verification system and method that achieves high speaker authentication accuracy and high user convenience by striking an efficient balance between accuracy and convenience. In so doing, the user is required to assist in developing a lengthy pass phrase, but reaps rewards over time by enjoying the ability to speak only a portion of the pass phrase that is sufficient in a given circumstance to accurately verify the speaker. Further convenience is obtained by using a sub-model-based spotting approach to render the system and method hands-free.

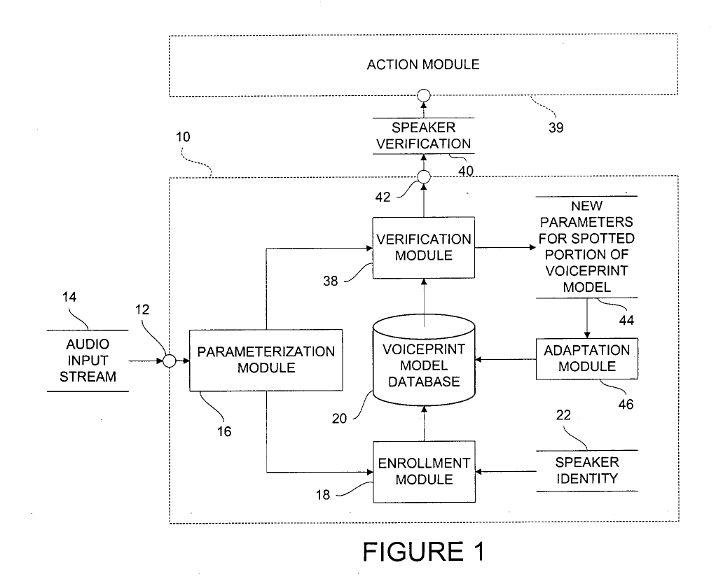

FIG. 1 illustrates a block diagram depicting a speaker verification system 10 according to the present invention that has several components. For example an audio input 12, such as a far-talking microphone, continuously receives an audio input stream 14 and communicates it as an analog or digital input signal to parameterization module 16, which generates acoustic parameter frames at predefined time intervals. A parameter frame describes the acoustic characteristics of a small segment of audio data (typically from 5 to 30 milliseconds). Also, enrollment module 18 is adapted to develop a speaker voiceprint model from one or several speaker utterances of a pass phrase that are present in the audio signal, and to store the speaker voiceprint model in data store 20 in association with a speaker identity 22, such as a speaker name, social security number, residence, and/or employee number.

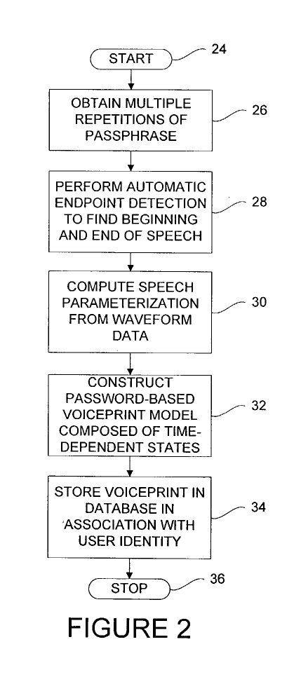

FIG. 2 illustrates a flow diagram depicting a speaker enrollment method according to the present invention and employed by input 12 (FIG. 1), parameterization module 16, and enrollment module 18. Beginning at 24 (FIG. 2), enrollment module 18 (FIG. 1) obtains one or several repetitions of a pass phrase uttered by the speaker at step 26 (FIG. 2), and may employ a dialogue manager and audio output (not shown) for this purpose. The use of a pass phrase helps to ensure that the system will not trigger simply on voice characteristics of the user, such as with casual conversation in the vicinity of the system, but will require a deliberate action on the part of the user. The pass phrase used by the speaker should be lengthy to allow for a plurality of sub-pass phrase portions, and may be assigned to or chosen by the speaker according to various sub-embodiments; thus, the pass phrase may be the same pass phrase for multiple speakers or different pass phrases for multiple speakers. An example implementation of the present invention employs a pass phrase consisting of a sequence of words taken from a closed-set lexicon to extract word-level voiceprint statistics, thereby preserving co-articulation phenomena specific to each user. An example pass phrase thus corresponds to the set of digits from “zero” through “nine”; a speaker would thus utter “zero, one, two, three, four, five, six, seven, eight, nine . . . ” once or several times during step 26 as part of an enrollment phase. Additional examples of pass phrases consisting of sequences of words taken from a closed-set lexicon include the alphabet letters from “A” to “Z”, and the military alphabet from “Alpha” to “Zulu”. Endpoint detection is also performed at step 28 during the enrollment phase to find the beginning and end of speech, and thus differentiate one utterance of the pass phrase from another. Speech parameterizations are further computed for all collected audio samples of the pass phrase at step 30, and a password-based voiceprint model is then developed from the parameterized utterance(s) at step 32. The voiceprint model is composed of time dependent states with each state describing a single frame or a sequence of frames. Additionally, each state has a reference count, initialized to zero, identifying how many times the state has been updated based on new data obtained during verification as further described below. Finally, at step 34, the developed model is stored in data store 20, optionally in association with speaker identity 22. The enrollment method ends at 36 (FIG. 2).

Returning to FIG. 1, system 10 further has verification module 38 adapted to find a match between a sub-model portion of the voiceprint model and a sub-stream portion of the input stream based on similarity between the sub-model portion and the sub-stream portion. Accordingly, verification module 38 finds an admissible alignment between a sub-model portion of the voiceprint model and a sub-stream portion of the input stream that yields an acceptable degree of similarity between the sub-model portion and the sub-stream portion. The verification module decides upon the admissibility of an alignment by checking whether or not that alignment can satisfy a set of constraints (explained in detail later) relative to the duration of the aligned portion and relative to the amount of additional training the corresponding states of the model have been submitted to up to that point in time via adaptation module 46. Verification module 38 is also adapted to notify action module 39 via output 42 after a successful verification of a speaker by communicating a speaker verification 40, such as the speaker's identity or a signal indicating a verification has occurred. Action module 39 can, for instance, be a door access control system adapted to grant access to the speaker upon validation of the registered user's identity. Verification module 38 is further adapted to communicate the matching sub-stream portion and sub-model portion 44 to update module 46, which is adapted to update the corresponding portion of the voiceprint model based on the matching sub-stream portion. In one aspect, verification module 38 is adapted to compare plural sub-model portions of varying duration to plural sub-stream portions of varying duration via dynamic time warping (DTW) or via other decoding techniques such as Baum-Welch decoding or Viterbi decoding. In another aspect, verification module 38 is adapted to use a duration constraint criterion to find an acceptable, matching sub-stream portion. Accordingly, the duration constraint is verified if the matching score for the sub-stream portion is better than a matching score threshold that varies based on duration of the spotted portion. In a preferred embodiment, that mechanism provides an ability to compensate for the lower score expectation of longer speech portions. Verification module 38 is also adapted to find the match based on a number of times the sub-model portion has been updated with speaker utterances of the pass phrase by rejecting the alignment hypothesis of under-trained sub-model portions. Whether a sub-model portion has been suitably trained is determined by averaging the number of times the corresponding state-specific reference counts of the spotted portion have been adapted and by comparing that average value to a duration-dependent threshold. In a preferred embodiment, that mechanism provides an ability to robustly assess the confidence/risk attached to a sub-model portion based on the number of sample data with which its states have been statistically trained. In an additional aspect, update module 46 is adapted to determine whether to update the corresponding portion of the voiceprint model based on Signal-to-Noise Ratio (SNR) measurement on the matching sub-stream portion to prevent the adaptation of the sub-model portion with noise corrupted data.

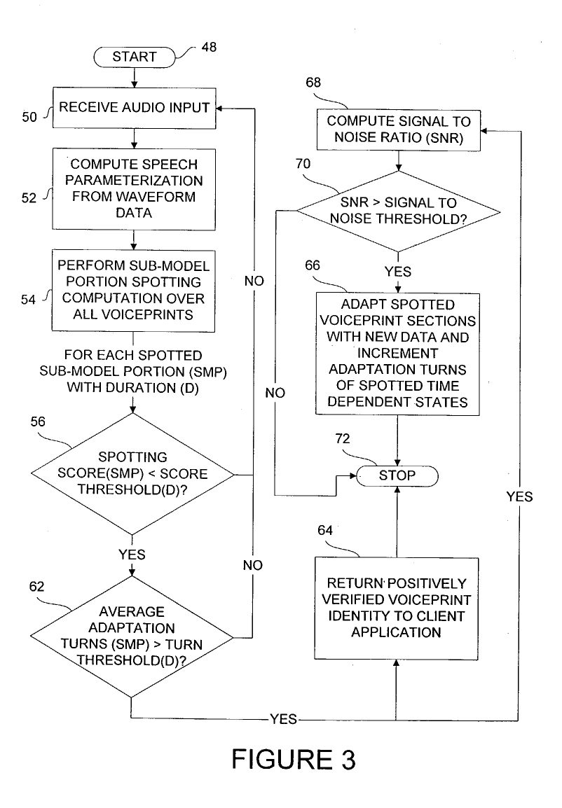

FIG. 3 illustrates a flow diagram depicting a speaker verification and model adaptation method according to the present invention and employed by input 12 (FIG. 1), parameterization module 16, and verification module 38 in concert with update module 46. Beginning at 48 (FIG. 3), the method includes receiving an audio input stream at step 50, which is parameterized at 52, and a similarity scoring technique is employed at step 54 to accomplish sub-password spotting over all voiceprints. In one embodiment, the similarity scoring technique according to the present invention executes a novel implementation of DTW to compare plural sub-model portions of varying duration to plural sub-stream portions of varying duration.

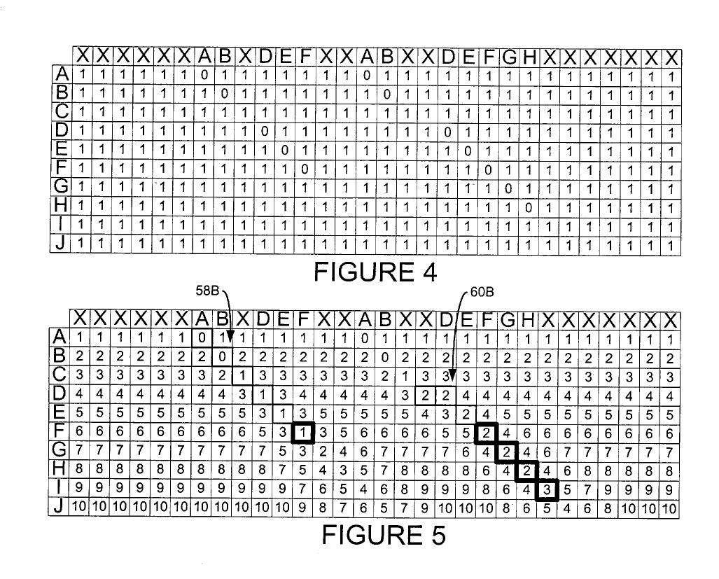

FIG. 4 illustrates a graph depicting a two-dimensional local distance array demonstrating local distance recordation accomplished via a similarity scoring technique according to the present invention and employed by verification module 38 (FIG. 1) in accomplishing step 54 (FIG. 2). Accordingly, a simplified example of the similarity scoring technique of the present invention is illustrated with time dependent states of the voice print model replaced by a string of characters “ABCDEFGHI”, and with the input stream consisting of characters either identifiable as one of those present in the voiceprint model, or not identifiable and designated as “X”. In operation, the similarity scoring technique initializes the two-dimensional local distance array of FIG. 7 for a voice print model on the ordinate and the input stream on the abscissa, and populates a column for a received character by comparing the received character to each character in the voiceprint model. Deemed similarity between the input character and the voiceprint model character causes the corresponding intersection cell to be populated with a “0”, while deemed dissimilarity causes the corresponding intersection cell to be populated with a “1”. Extending the technique to frames used in speech recognition, one would compute for instance the Euclidean distance between an input frame and each model state, and measure the similarity/dissimilarity by normalizing the distance value as a real number comprised between 0 and 1. The array, like other arrays further described below, is circular in nature since similarity scores for a particular input only need to be retained for a finite period of time based, for example, on the maximum length of a voice print. The binary representation of similarity used to demonstrate the similarity scoring technique is optional, and it should be readily understood that other methods of quantifying the local distances could be employed.

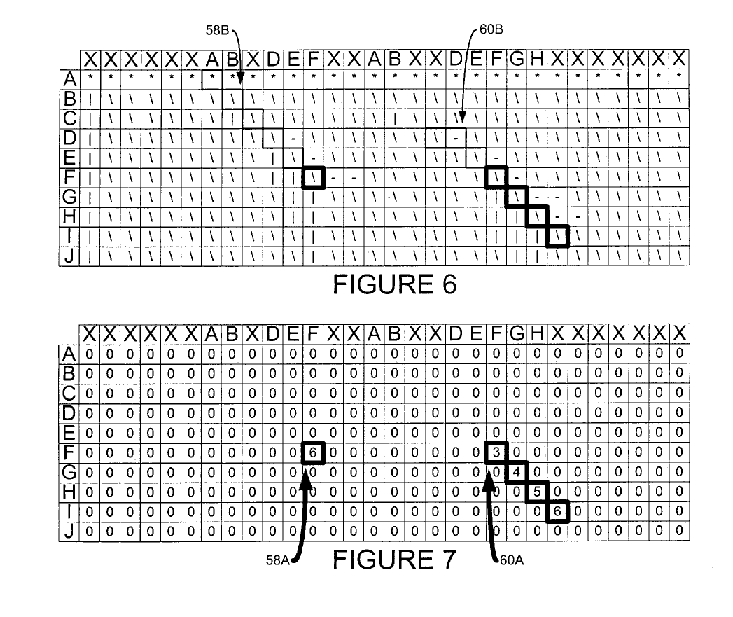

FIG. 5 illustrates a graph depicting a two-dimensional accumulation score array demonstrating accumulation score recordation accomplished via a similarity scoring technique according to the present invention and employed by verification module 38 (FIG. 1) to accomplish step 54 (FIG. 3). Accordingly, costs for a particular accumulation cell of the accumulation score array of FIG. 5 are identified and recorded by taking the local cost for the corresponding cell of the local distance array of FIG. 4, and adding it to the least accumulated cost among the three or less accumulation cells located directly above, to the left, or diagonally above and to the left of the particular accumulation cell of FIG. 5. The decision of whether to take the accumulated cost of the top adjacent accumulation cell “|”, left adjacent accumulation cell “-”, or diagonally above and to the left accumulation cell “\” is further recorded in two-dimensional multiple path array of FIG. 6. The symbol “*” in FIG. 6 denotes the beginning of a path.

FIG. 7 illustrates a graph depicting a two-dimensional sub-model spotting array demonstrating sub-model spotting recordation accomplished via a similarity scoring technique according to the present invention and employed by verification module 38 (FIG. 1) to accomplish step 54 (FIG. 3), and decision step 56 for each spotted sub-model portion (SMP) with duration (D). Accordingly, each cell contains information that represents the longest sub-portion of the pass phrase that passes the duration-dependent threshold. Each cell provides the duration (D) of the longest spotted sub-model portion, the average matching score (not shown), the corresponding sub-string in the input (not shown) and the corresponding sub-string in the model (not shown). The search for spotting a sub-model portion (SMP) makes use of the multiple path array. Typically each time a new frame is ready for processing, the corresponding elements in the accumulation score array are computed and the new path decisions are memorized in the multiple path array. Then, for each possible state of the model, the technique traces the path back up to the beginning of the model to examine all sub-model portions from that point. Positive speaker verifications at 58A and 60A (FIG. 7) therefore result from relevant portions of traceback paths 58B and 60B. In operation, the similarity scoring technique computes the similarity score between sub-model and sub-stream portions as a difference between values stored in the accumulation score array to measure the change in accumulation score across a portion of a recorded path. Each similarity score is normalized by dividing it by the duration of the sub-model portion, and the normalized similarity score is compared with an associated duration-dependent threshold to determine whether a sub-model portion is spotted. The duration-dependent threshold increases with duration to allow for increased dissimilarity over a lengthier sub-model portion; thus, the requirements for spotting a sub-model portion of lesser duration are more stringent than those for spotting a sub-model portion of greater duration.

The following algorithm essentially performs the functions described above with respect to populating a particular cell of the sub-model spotting array based on the accumulation score array ($AccumulationScoreArray) and the multiple path array ($MultiplePathArray), wherein the trace back from a particular cell follows the relevant path upwards and to the left using “Tail” to index a particular cell to be populated, and “Head” to index the cell that is furthest back along the path for a particular recursion:

```
set HeadModelIndex $ModelIndex
set HeadinputIndex $InputIndex
while {$HeadModelIndex != −1} {
  set Direction $MultiplePathArray($HeadInputIndex,$HeadModelIndex)
  if {$Direction= =$DirectionTable(Diagonal)} {
    set NextHeadModelIndex [expr $HeadModelIndex-1]
    set NextHeadInputIndex [expr $HeadInputIndex-1]
  } elseif {$Direction= =$DirectionTable(Up)} {
    set NextHeadModelIndex [expr $HeadModelIndex-1]
    set NextHeadInputIndex $HeadInputIndex
  } elseif {$Direction= =$DirectionTable(Left)} {
    set NextHeadModelIndex $HeadModelIndex
    set NextHeadInputIndex [expr $HeadInputIndex-1]
  } else {
    set NextHeadModelIndex [expr $HeadModelIndex-1]
    set NextHeadInputIndex [expr $HeadInputIndex-1]
  }
    set HeadAcoumulationScore
  $AccumulationScoreArray($NextHeadInputIndex,
  $NextHeadModelIndex)
    set Duration [expr $TailModelIndex-$HeadModelIndex+1]
    if {($Duration>0) && ($AverageThreshold($Duration)>0)} {
    set Difference [expr $TailAccumulationScore-
    $HeadAccumulationScore]
    set Average [expr (1.0*$Difference)/$Duration]
    if {($Average<=$AverageThreshold($Duration))} {
      set InputPortion [string range $Input $HeadInputIndex
      $TailInputIndex]
      set ModelPortion [string range $Model $HeadModelIndex
      $TailModelIndex]
      set Delta [expr $AverageThreshold($Duration)-$Average]
      set DetectionArray($InputIndex,$ModelIndex) [concat
      $Duration $Average
$InputPortion $ModelPortion]
    }
  }
}
```

The preceding algorithm produces cells like those in FIG. 7 based on the arrays of FIG. 5 and FIG. 6 when the following duration-dependent thresholds ScoreThreshold(D) are employed for duration D:

ScoreThreshold(1)=−0.0522068261938

ScoreThreshold(2)=0.0

ScoreThreshold(3)=0.0480256246041

ScoreThreshold(4)=0.0924904078964

ScoreThreshold(5)=0.133886130789

ScoreThreshold(6)=0.172609243471

ScoreThreshold(7)=0.208984016561

ScoreThreshold(8)=0.243279064865

ScoreThreshold(9)=0.275719397627

ScoreThreshold(10)=0.30649537426

In this example, all spotted sub-portions have a minimum duration of three.

According to one embodiment, the main algorithm reinitializes when a spot occurs to help ensure that multiple spots are not made from a recognizable input, and a time delay may be further employed as needed to assist in accomplishing this end. As a result of this implementation, only one spot of duration three would likely occur at 60A (FIG. 7) and, if the re-initialization delay is sufficiently long, no spot would occur at 60A in view of the spot at 58A of duration six.

Once a sub-model portion is spotted, the verification method further includes determining whether the average adaptation turns for the spotted sub-model portion is high enough for verification to accurately occur at decision step 62 (FIG. 3). Shortly after the speaker has enrolled, therefore, the speaker will need to speak most or all of the pass phrase to accomplish verification. Over time, however, the speaker may progressively more frequently gain entry by speaking smaller and smaller portions of the pass phrase. If a sub-model portion passes the test for similarity score and sufficient adaptation turns, then a speaker verification is issued to the client application at step 64; otherwise, additional audio input is received at step 50. Also, successful spotting of a sub-model portion causes the voiceprint model stored in memory to be updated with input time dependent states of the sub-stream portion mapped by multiple path array and matching sub-stream portion to corresponding time dependent states of the voiceprint model at step 66, and the adaptation turns reference counts of the corresponding time dependent states of the voiceprint model are incremented. The update only occurs, however, if signal to noise ratio computed at 68 for the input sub-stream portion is high enough as at 70 to ensure that the voice print model will not be degraded in the process. The method ends at 72.

The description of the invention is merely exemplary in nature and, thus, variations that do not depart from the gist of the invention are intended to be within the scope of the invention. For example, it should be readily understood that spotting may occur by matching a sub-model portion to a sub-stream portion, and that duration can be defined in terms of the sub-stream portion. It should also be readily understood that the present invention may be alternatively employed without continuous speech recognition and with various alternative forms of speech recognition that may or may not include word spotting or DTW; thus, hidden markov modeling (HMM) or Gaussian mixture modeling (GMM). Further, the duration-dependency of the thresholds may be modifiable based, for example, on a state of alert to increase security at critical times. Such variations are not to be regarded as a departure from the spirit and scope of the invention.

What is claimed is:

1. A speaker verification system for use with a security system, comprising:
a data store containing a speaker voiceprint model developed from at least one speaker utterance of a pass phrase;
an audio input receptive of an audio input stream; and
a verification module adapted to find a match between a sub-model portion of the voiceprint model and a sub-stream portion of the input stream based on similarity between the sub-model portion and the sub-stream portion, and adapted to issue a speaker verification based on the match.

2. The system of claim 1, wherein said verification module is adapted to find the match based on duration of at least one of the sub-model portion and the sub-stream portion.

3. The system of claim 1, wherein said verification module is adapted to find the match based on the number of times the sub-model portion has been updated with utterances made by the speaker after the initial training.

4. The system of claim 1, wherein said verification module is adapted to compare plural sub-model portions of varying duration to plural sub-stream portions of varying duration.

5. The system of claim 1, comprising a parameterization module adapted to generate parameters describing time dependent frames of the input stream.

6. The system of claim 1, comprising an update module adapted to update the sub-model portion of the voiceprint model based on a matching sub-stream portion.

7. The system of claim 6, wherein said update module is adapted to determine whether to update the sub-model portion based on signal to noise ratio of the matching sub-stream portion.

8. The system of claim 1, comprising an enrollment module adapted to develop the speaker voiceprint model from speaker utterances of the pass phrase.

9. The system of claim 8, wherein said enrollment module is adapted to store the speaker voiceprint model in said data store in association with a speaker identity.

10. The system of claim 1, wherein said data store contains speaker voiceprint models associated with speaker identities, and wherein said verification module is adapted to identify a verified speaker via a speaker identity associated with a speaker voiceprint model having a matched sub-model portion.

11. A speaker verification method for use with a security system, comprising:
receiving an audio input stream
finding a match between a sub-model portion of a speaker voiceprint model and a sub-stream portion of the input stream based on similarity between the sub-model portion and the sub-stream portion; and
issuing a speaker verification based on the match.

12. The method of claim 11, wherein said finding the match includes considering duration of at least one of the sub-model portion and the sub-stream portion.

13. The method of claim 11, wherein said finding the match includes considering a number times the sub-model portion has been updated with speaker utterances of the pass phrase.

14. The method of claim 11, comprising comparing plural sub-model portions of varying duration to plural sub-stream portions of varying durations via dynamic time warping.

15. The method of claim 11, comprising the generation of parameters describing time dependent frames of the input stream.

16. The method of claim 11, comprising the updating of the sub-model portion of the voiceprint model based on a matching sub-stream portion.

17. The method of claim 16, comprising determining whether to update the sub-model portion based on signal to noise ratio of the matching sub-stream portion.

18. The method of claim 1, developing the speaker voiceprint model from speaker utterances of the pass phrase.

19. The method of claim 18, comprising storing the speaker voiceprint model in a data store in association with a speaker identity.

20. The method of claim 11, comprising identifying a verified speaker via a speaker identity associated with a speaker voiceprint model having a matched sub-model portion.
